(19) United States
(12) Patent Application Publication
(10) Pub. No.: US 2006/0136567 A1
(43) Pub. Date: Jun. 22, 2006

(54) Communication control apparatus and communication control method

(75) Inventors: Tatsuya Muramatsu, Fuchu-shi (JP); Toshifumi Shiba, Iruma-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/289,454

(22) Filed: Nov. 30, 2005

(30) Foreign Application Priority Data
Nov. 30, 2004 (JP) 2004-346556

(51) Int. Cl. G06F 15/16

(52) U.S. Cl. 709/217

(57) ABSTRACT

A communication control apparatus for executing a data transfer process between an external network and an internal network, includes a first port connected to the internal network, a second port connected to the external network, a storage unit, a determining unit which determines whether or not information to specify an operation environment of the communication control apparatus relating to a data transfer process of network layer level is stored in the storage unit, and an executing unit which executes the data transfer process at the network layer level between the first port and the second port based on the information when the determining unit determinates that the information is stored in the storage unit and executes a data transfer process at data link layer level between the first port and the second port when the determining unit determinates that the information is not stored in the storage unit.

### CROSS-REFERENCE TO RELATED APPLICATIONS

This application is based upon and claims the benefit of priority from the prior Japanese Patent Application No. 2004-346556, filed Nov. 30, 2004, the entire contents of which are incorporated herein by reference.

### BACKGROUND

1. Field

The present invention relates to a communication control apparatus for executing data transfer process between an external network and an internal network and to a communication control method used for the apparatus.

2. Description of the Related Art

An Internet Protocol (IP) router is conventionally known as a communication control apparatus for connecting between networks at a network layer level (the third layer of an open system interconnection OSI reference model).

The IP router disclosed in Jpn. Pat. Appln. KOKAI Publication No. 9-135261 executes route control of IP packets at the network layer level. This IP router also has a function of automatically acquiring network address information from received IP packets.

In recent years, the router has been used as the communication control apparatus for connecting between the internal network and the external network such as the Internet even at home and in an office, etc. This router functions as a broadband router to be one type of the IP router.

The broadband router has a wide area network (WAN) port connected to the external network and a local area network (LAN) port connected to the internal network. This router also has a network address translation (NAT) and IP masquerade functions, etc., as a function of executing the data transfer process between the internal network and the external network.

NAT is a function of translating a local IP address (also referred to as private IP address) used in the internal network to a global IP address used in the external network. IP masquerade is a function of assigning a plurality of local IP addresses to one global IP address. The IP address is a network address for identifying each node in the network layer level (the third layer of OSI reference model). The router executes a data transfer process of the network layer level between the LAN port and the WAN port. The data transfer process of the network layer level are executed in accordance with environment setting information which is set in the router and is related to the data transfer process of the network layer level.

However, the communication between the LAN port and the WAN port is always executed through the network layer. Therefore, the WAN port is still disconnected from the LAN port in as far as the environment setting information is not set, and the data transfer process from the LAN port side to the WAN port side cannot be executed. Accordingly, a user has to surely perform an operation to set the environment setting information in the router to connect to the Internet via the router from a terminal on the internal network.

Consequently, a communication control apparatus and the communication control method capable of executing the data transfer process between the internal network and the external network are desired even if the environment setting information has not been set in the apparatus.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a system configuration of a communication control apparatus regarding an embodiment of the present invention;

FIG. 2 is a view for explaining a relay level of data transfer process executed by the communication control apparatus regarding the embodiment;

FIG. 3 is a view for explaining an environment setting information process executed through the communication control apparatus regarding the embodiment;

FIG. 4 is a view for explaining a switching hub operation executed by the communication control apparatus regarding the embodiment;

FIG. 5 is a view for explaining an IP router operation executed by the communication control apparatus regarding the embodiment;

FIG. 6 is a flowchart for explaining transfer process mode procedure executed by the communication control apparatus regarding the embodiment; and

FIG. 7 is a flowchart for explaining a process procedure executed by a communication terminal connected to the communication control apparatus regarding the embodiment.

### DETAILED DESCRIPTION

Hereinafter, an embodiment of the present invention will be explained by referring to drawings.

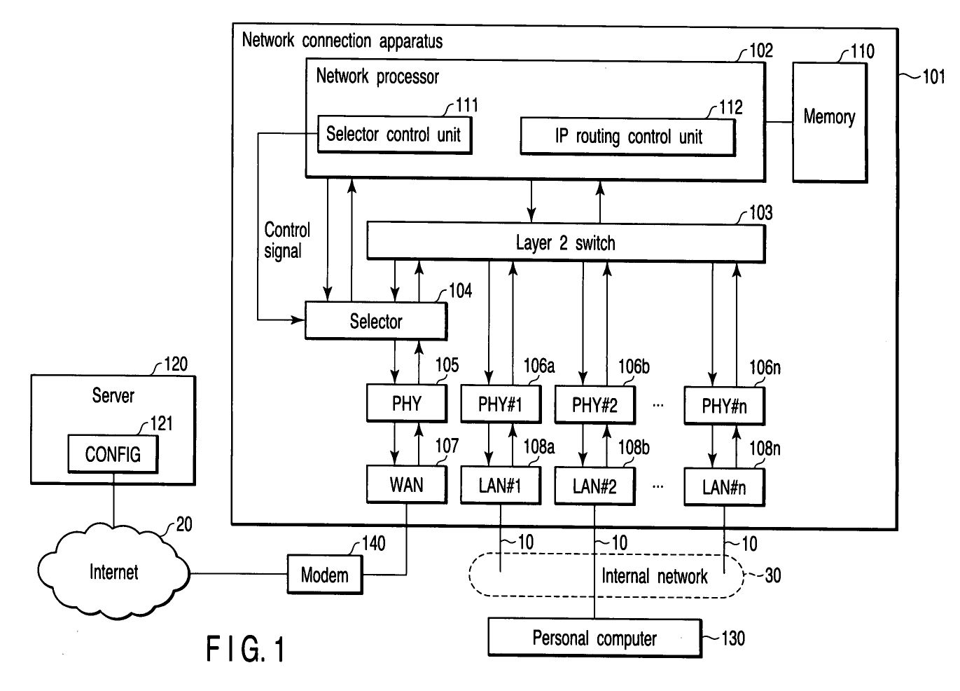

FIG. 1 shows a configuration of a communication control apparatus regarding an embodiment of the present invention. This communication control apparatus functions as, for example, an network connection apparatus 101 for connecting between an internal network 30 and an external network 20 such as the Internet or an intranet. The internal network 30 is, for example, a local network such as a LAN installed at home.

The network connection apparatus 101 is designed to operate as a broadband router that is one kind of IP router. The internal network 30 is composed of a plurality of network segments (LAN segments) 10. A personal computer 130 is connected to the internal network 30. The personal computer 130 is a communication terminal for accessing the external network and a server computer or the like on the external network 20 through the network connection apparatus 101.

The network connection apparatus 101 composed of a network processor 102, a selector 104, a layer 2 switch 103, a WAN side physical sublayer transceiver IC (PHY) 105, LAN side physical sublayer transceiver ICs (PHY#1-PHY#n) 106a-106n, WAN port (WAN) 107, LAN ports (LAN#1-LAN#n) 108a-108n, a memory 110 and the like.

The LAN ports 108a-108n are connected to a plurality of network segments (LAN segments) 10, respectively. The WAN port 107 is connected to the external network 20 via a modem 140.

The network processor 102 is a processor to control operations of the network connection apparatus 101. The network processor 102 functions as a layer 3 switch for executing a data transfer process of network layer level between the WAN port 107 and the LAN ports 108a-108n, respectively. The network layer is the third layer of an OSI reference model. The data transfer process of the network layer level utilize a network address (IP address). The network processor 102 is connected to the PHY 105 corresponding to the WAN port 107 through the selector 104. The network processor 102 is connected to the LAN side transceiver ICs (PHY#1-PHY#n) 106a-106n corresponding to LAN ports 108a-108n through the layer 2 switch 103, respectively.

Furthermore, the network processor 102 also has a NAT function, an IP masquerade function, a dynamic host configuration protocol (DHCP) server function, and the like, in order to execute the data transfer process of the network layer level. The DHCP server function is a function of assigning network addresses (local IP addresses) to each communication terminal on the internal network 30. Moreover, the network processor 102 has a function of resetting (initializes) the WAN port 107 and LAN ports 108a-108n to disconnect communication links between the LAN ports 108a-108n and the internal network 30.

The transceiver IC (PHY) 105 transmits and receives physical data to and from the external network 20 via the WAN port 107.

Each transceiver IC (PHY#1-PHY#n) 106a-106n transmits and receives the physical data to and from the corresponding network segment though one of the corresponding LAN ports (LAN#1-LAN#n) 108a-108n.

The layer 2 switch 103 is connected to the LAN ports 108a-108n through the transceiver ICs 106a-106n.

The layer 2 switch 103 executes data transfer process at the data link layer level among the LAN ports 108a-108n with one another. The data link layer is the second layer of the OSI reference model. The data transfer process at the data link layer level utilize, for example, an address (physical address) such as a media access control (MAC) address.

The layer 2 switch 103 is also connected to the transceiver IC (PHY) 105 corresponding to the WAN port 107.

The selector 104 selectively connects the WAN port 107 to the network processor 102 and the layer 2 switch 103 through the transceiver IC (PHY) 105. When the selector 104 connects the transceiver IC (PHY) 105 to the layer 2 switch 103, the layer 2 switch 103 executes the data transfer process at the data link layer level among all ports including the WAN port 107 and the LAN ports 108a-108n. In this case, the WAN port 107 is treated as a port belonging to the same switching fabric as that of the LAN ports 108a-108n.

The network processor 102 execute control for the selector 104. The network processor 102 has a selector control unit 111 and an IP routing control unit 112.

The IP routing control unit 112 is a layer 3 switch to execute the data transfer process at the network layer level among the WAN port 107 and each LAN port 108a-108n, respectively, based on environment setting information related to the data transfer process at the network layer level. The environment setting information is storage in the memory 110.

The environment setting information is necessary information so as to operate the network connection apparatus 101 as the broadband router (IP router) and specifies an operation environment for the network connection apparatus 101 related the data transfer process of the network layer level. This environment setting information is composed of, for example, routing information specifying communication environments on a side of the internal network 20 and on a side of the external network 20, respectively. The information specifying the communication environment on the side of the external network 20 includes an IP address (global address) to be assigned on a side of the WAN port 107, and an IP address of a domain name system (DNS) server. The information specifying the communication environment on a side of the internal network 30 includes the IP addresses (local IP addresses) to be assigned to sides of the LAN ports 108a-108n.

The selector control unit 111 has a function for determining whether or not the operation environment of the network connection apparatus 101 has been set, namely, the environment setting information has been stored in the memory 110. The selector control unit 111 generates a control signal to control operations of the selector 104 in accordance with the determination result. The memory 110 is composed of, for example, a storage device such as a nonvolatile memory or the like.

If the memory 110 has not stored the environment setting information thereon, that is, the operation environment of the network connection apparatus 101 has not been set yet, the control unit 111 controls the selector 104 to connect the transceiver IC (PHY) 105 to the layer 2 switch 103. In contrast, if the memory 110 has already stored the environment setting information thereon, that is, the operation environment of the network connection apparatus 101 has been set, the control unit 111 controls the selector 104 to connect the transceiver IC (PHY) 105 to the network processor 102.

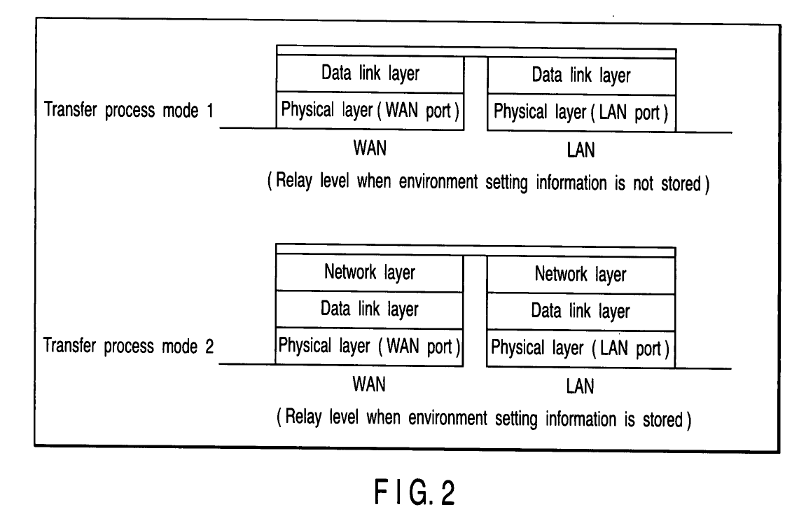

With the operations of the selector 104, the network connection apparatus 101 can operate, as shown in FIG. 2, in either of two data transfer process modes, which are a transfer process mode 1 and a transfer process mode 2.

The transfer process mode 1 is a transfer process mode for relaying among the WAN port 107 and each LAN port 108a-108n at the data link layer level. In this transfer process mode 1, the network connection apparatus 101 functions as the switching hub and executes the data transfer process (data transfer process control at data link layer level including error detection and correction) among all ports including the WAN port 107 and the LAN ports 108a-108n. In this case, the external network 20 and the internal network 30 are treated that they belong to the identical network. The data transfer process between the WAN port 107 and each LAN port 108a-108n is executed not through the network processor 102, but through the layer 2 switch 103.

If the memory 110 has not stored the environment setting information, the transfer process mode 1 is selected. Thereby, the network connection apparatus 101 can execute the data transfer process from each LAN port 108a-108n to the WAN port 107. Therefore, the personal computer 130 can easily access to the external network 20 through the layer 2 switch 103 of the network connection apparatus 101. That is, in the transfer process mode 1, the personal computer 130 can communicate with the external network 20 in a manner that the personal computer 130 is directly connected to the modem 140.

The transfer process mode 2 is a transfer process mode to relay between the WAN port 107 and each LAN port 108a-108n at the network layer level. That is, in the transfer process mode 2, the network connection apparatus 101 functions as the broadband router (IP router) to execute data transfer process (network address control, quality of service [QoS] control, data transfer process control based on network layer level) among the WAN port 107 and the LAN ports 108a-108n in accordance with the environment setting information stored in the memory 110. In this case, the functions of the NAT, IP masquerade, the DHCP server, and the like also become effective.

If the memory 110 has stored the environment setting information therein, the transfer process mode 2 is selected. Therefore, after setting the environment setting information to the network connection apparatus 101, the network connection apparatus 101 relays between the external network 20 and the internal network 30 at the network layer level.

The network processor 102 periodically monitors whether or not the environment setting information is stored in the memory 110. If the personal computer 130 writes in the environment setting information in the memory 110, the network processor 102 controls the selector 104 to switch the connection destination of the transceiver IC (PHY) 105 from the layer 2 switch 103 to the network processor 102. Thereby, the transfer process mode of the network connection apparatus 101 is switched from the transfer process mode 1 to the transfer process mode 2.

As mentioned above, the network connection apparatus 101 executes the data transfer process among the WAN port 107 and each LAN port 108a-108n at the data link layer level until the environment setting information set in the network connection apparatus 101. Therefore, until the environment setting information has been set in the network connection apparatus 101, the personal computer 130 can access the external network 20 such as the Internet or the like in a manner as if the personal computer 130 is directly connected to the modem 140. Accordingly, the personal computer 130 can also acquire the environment setting information to be set to the network connection apparatus 101 from the external network 20.

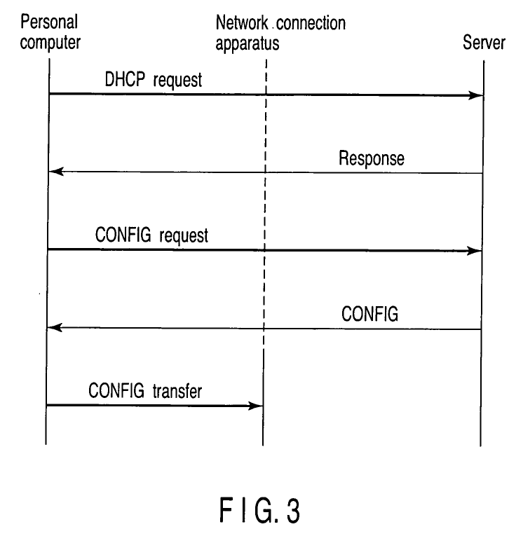

Next, an example of process to acquire the environment setting information from the external network 20 will be described by referring to FIG. 3. Here, it is assumed that environment setting information (CONFIG) 121 to be set in the network connection apparatus 101 has been stored in the server computer 120.

As described above, the personal computer 130 connected the LAN port 108b is connected to the WAN port 107 through only the layer 2 switch 103 until the environment setting information (CONFIG) 121 is set to the network connection apparatus 101. The network connection apparatus 101 executes the data transfer process at the data link layer level between the WAN port 107 and the LAN port 108b.

The personal computer 130 broadcasts, for example, DHCP request packets. These DHCP request packets are transmitted to all network segments in the internal network 30 and also transmitted to the external network 20 through the WAN port 107 and the modem 140.

The server computer 120 is configured to respond to the broadcast DHCP request packet. When receiving the DHCP request packet, the server computer 120 transmits response packet to the personal computer 130. The response packet includes the global IP address to be assigned to the personal computer 130. The personal computer 130 acquires its own global IP address and then can communicate with an arbitrary server on the external network 20.

A user of the personal computer 130 transmits, for example, a CONFIG request packet to request the environment setting information (CONFIG) 121 to the global IP address of the server computer 120, which is described in a instruction manual, etc., of the network connection apparatus 101. This CONFIG request packet is transmitted to the external network 20 through the network connection apparatus 101 and the modem 140.

When receiving this CONFIG request, the server computer 120 executes the transfer processes of the environment setting information (CONFIG) 121 to the personal computer 130. Thereby, the personal computer 130 can acquires the environment setting information (CONFIG) 121. The user of the personal computer 130 transfers the environment setting information (CONFIG) 121 to the local IP address of the network connection apparatus 101 by the file transfer protocol (FTP), etc. The local IP address is described, for example, in the instruction manual of the network connection apparatus 101.

The network connection apparatus 101 executes process to write the environment setting information (CONFIG) 121 transferred from the personal computer 130 to the memory 110. When the environment setting information (CONFIG) 121 is written in the memory 110, the transfer process mode of the network connection apparatus 101 is automatically switched from the transfer process mode 1 to the transfer process mode 2. Thereby, the network connection apparatus 101 starts to operate as the IP router.

Although the network connection apparatus 101 transmits the CONFIG request packet and the like by means of manual operations by the user as mentioned above, the network connection apparatus 101 also can automatically execute the whole processes of the personal computer 130 described with reference to FIG. 3 by installing a program to set the operation environment of the network connection apparatus 101 into the personal computer 130.

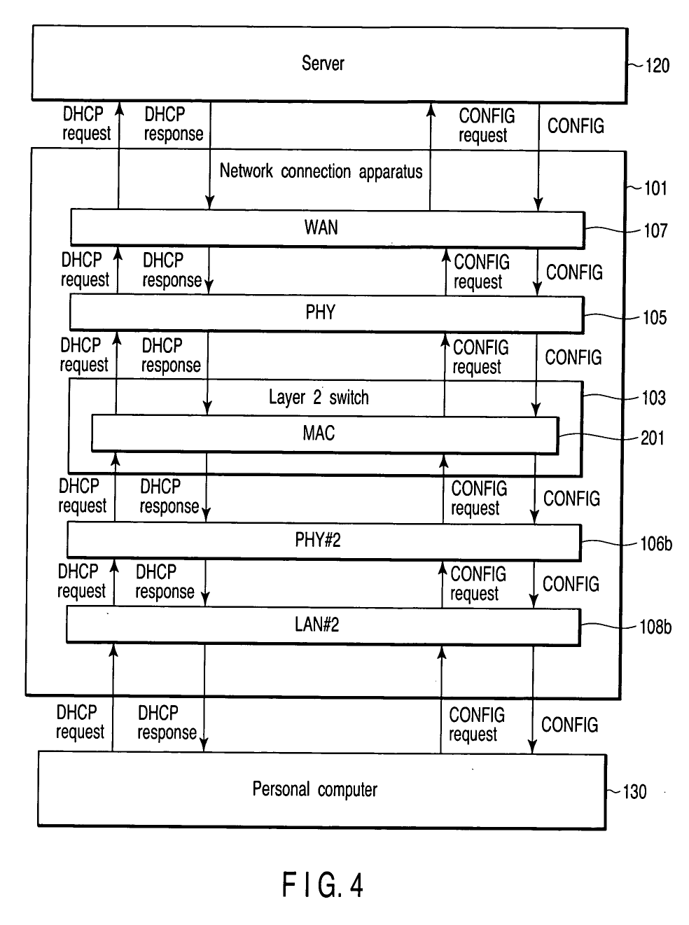

Next, the operations of the network connection apparatus 101 in the transfer process mode 1 will be described by taking the environment information acquiring process as an example with reference to FIG. 4.

If the memory 110 has not stored the environment setting information (CONFIG) 121, the WAN side physical transceiver IC (PHY) 105 is connected to the MAC 201 of the layer 2 switch 103 by the selector 104 and separated from the network processor 102. The MAC 201 is connected to the LAN side physical transceiver IC (PHY#2) 106b. Thereby, the LAN port (LAN#2) 108b and the WAN port 107 become belonged to the identical switch fabric. The personal computer 130 can access to the external network 20 through the network connection apparatus 101 operating as the switching hub and the modem 140.

The LAN port (LAN#2) 108b receives the DHCP request packet from the personal computer 130. The DHCP request packet is sent to the server computer 120 on the external network 20 through the LAN side physical transceiver IC (PHY#2) 106b, the layer 2 switch 103, the WAN side physical transceiver IC (PHY) 105 and the WAN port (WAN) 107.

The WAN port 107 receives the response packet (DHCP responses) from the server computer 120. The response packet is sent to the personal computer 130 through the WAN side physical transceiver IC (PHY) 105, the layer 2 switch 103, the LAN side physical transceiver IC (PHY#2) 106b and the LAN port (LAN#2) 108b.

The LAN port (LAN#2) 108b receives the CONFIG request packet from the personal computer 130. The CONFIG request packet is sent to the server computer 120 on the external network 20 through the LAN side physical transceiver IC (PHY#2) 106b, the layer 2 switch 103, the WAN side physical transceiver IC (PHY) 105 and the WAN port (WAN) 107.

The WAN port 107 receives the environment setting information (CONFIG) packet from the server computer 120. The environment setting information (CONFIG) packet is sent to the personal computer 130 through the WAN side physical transceiver IC (PHY) 105, the layer 2 switch 103, the LAN side physical transceiver IC (PHY#2) 106b and the LAN port (LAN#2) 108b.

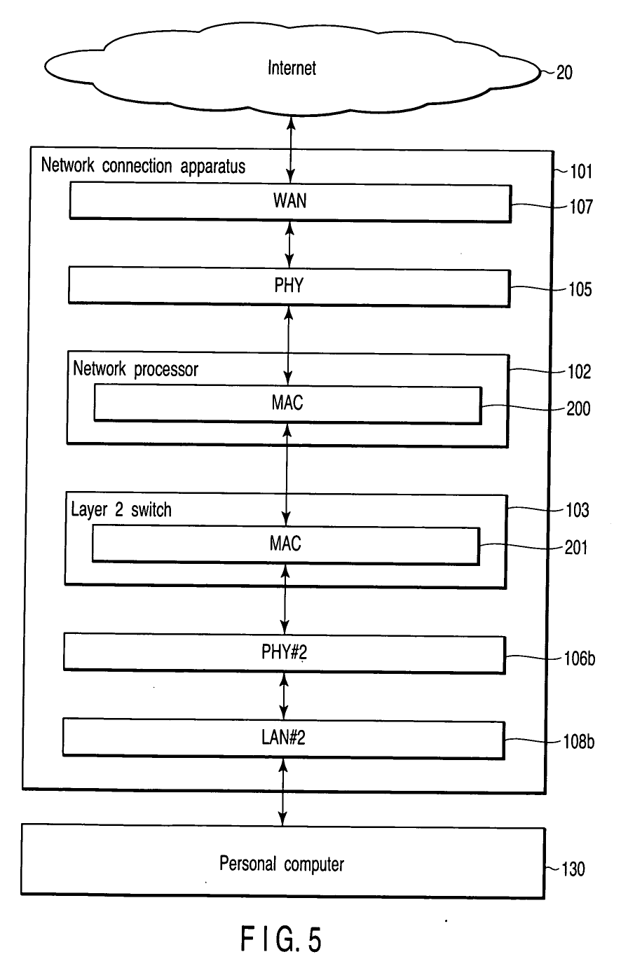

Next, the operations of the network connection apparatus 101 operating as a router will be described by referring to FIG. 5. When the memory 110 stores the environment setting information (CONFIG) 121 therein, the selector control unit 111 transmits the control signal to the selector 104. The selector 104 connects the WAN side physical transceiver IC (PHY) 105 to the MAC 200 of the network processor 102 by using the control signal.

The LAN port (LAN#2) 108b receives the packet from the personal computer 130. The packet received at the LAN port (LAN#2) 108b is sent to the external network 20 through the LAN side physical transceiver IC (PHY#2) 106b, the layer 2 switch 103, the network processor 102, the WAN side physical transceiver IC (PHY) 105 and the WAN port (WAN) 107. In this case, the network processor 102 also executes a process to translate a source local IP address included in the packet into the global IP address of the network connection apparatus 101.

The WAN port (WAN) 107 receives the packet from the external network 20. The packet received at the WAN port (WAN) 107 is sent to the personal computer 130 through the WAN side physical transceiver IC (PHY) 105, the network processor 102, the layer 2 switch 103, the LAN side physical transceiver IC (PHY#2) 106b and the LAN port (LAN#2) 108b. In this case, the network processor 102 executes a process to translate a destination global IP address included in the packet into the local IP address of the personal computer 130.

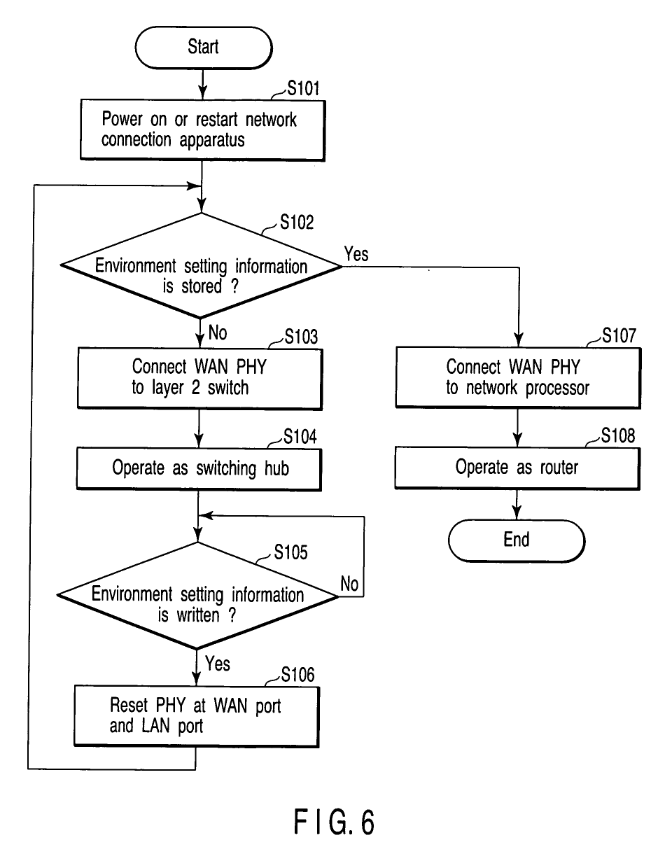

Next, control processes for the transfer process mode executed by the network connection apparatus 101 will be described by referring to the flowchart in FIG. 6.

When the network connection apparatus 101 is powered on or restarted (step S101), the network processor 102 executes the process to determine whether or not the memory 110 has stored the environment setting information (CONFIG) 121, that is, whether or not the operation environment of the network connection apparatus 101 has been set (step S102).

If the memory 110 has not stored the environment setting information (CONFIG) 121 (NO, in step S102), the network processor 102 connects the WAN side physical transceiver IC (PHY) 105 to the MAC 201 of the layer 2 switch 103 by means of the selector 104 (step S103). Thereby, the network connection apparatus 101 functions as the switching hub to execute the data transfer process at the data link layer level among all ports including the WAN port 107 and the LAN ports 108a-108n (step S104).

The network processor 102 periodically monitors whether or not the memory 110 has stored the environment setting information (CONFIG) 121. When the personal computer 130 writes in the environment setting information (CONFIG) 121 to the memory 110 (YES, in step S105), the network processor 102 resets (initializes) the LAN ports 108a-108n to disconnect the communication link between the LAN port (LAN#2) 108b and the personal computer 130. Specifically, in the step S106, the network processor 102 executes processes to reset the WAN side physical transceiver IC (PHY) 105 and the LAN side physical transceiver ICs 106a-106n.

After this, the network processor 102 controls the selector 104 to connect the WAN side physical transceiver IC (PHY) 105 to the MAC 200 of the network processor 102 (step S107). Thereby, the network connection apparatus 101 functions as the IP router to execute the data transfer process at the network layer level among the WAN port 107 and the LAN ports 108a-108n (step S108). In this case, the NAT function, the IP masquerade function and the DHCP server function are also become effective.

The personal computer 130, the communication link of which to the LAN port (LAN#2) 108b is disconnected, broadcasts the DHCP request packet in order to acquire the IP address. With response to the DHCP request packet, the network connection apparatus 101 assigns the local IP address to the personal computer 130. Thereby, the personal computer 130 can communicate with the external network 20 through the network connection apparatus 101 functioning as the IP router.

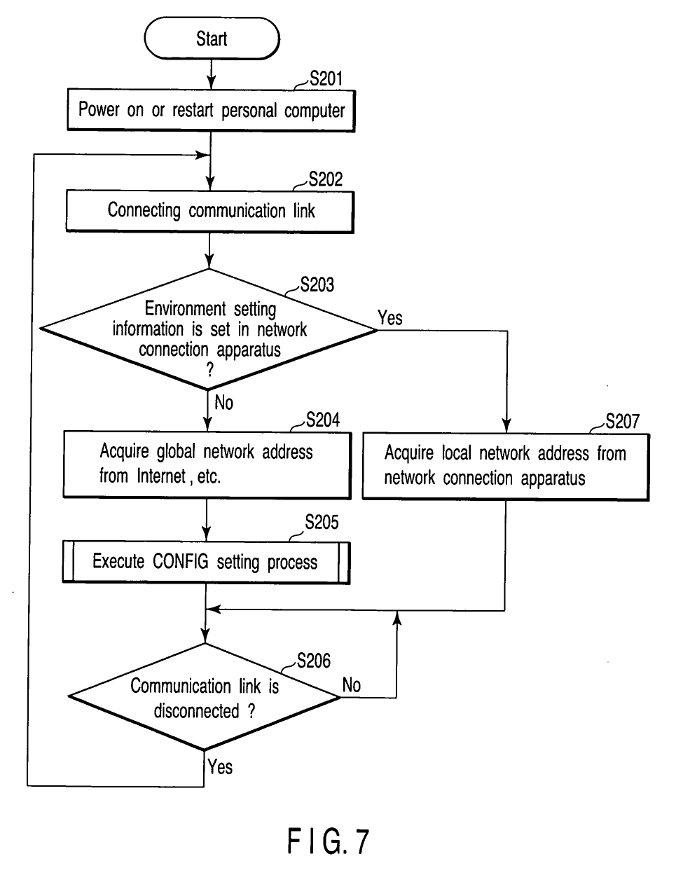

Next, operations of the personal computer 130 will be described by referring to the flowchart in FIG. 7.

When being powered on or restarted (step S201), the personal computer 130 starts process to establish a communication link between the network connection apparatus 101 and the personal computer 130 (step S202). In the step S202, the personal computer 130 broadcasts the DHCP request packet. If the environment setting information (CONFIG) 121 has not been set to the network connection apparatus 101 (NO, in step S203), the server computer 120 accepts the DHCP request packet. Thereby, the personal computer 130 acquires the global network address (global IP address) (step S204). The personal computer 130 uses the acquired global network address to acquire the environment setting information from the server computer 120 on the external network 20 and executes the process to set the acquired environment setting information to the network connection apparatus 101 (step S205).

After this, when being disconnected the communication link to the network connection apparatus 101 (YES, in step S206), the personal computer 130 executes again the process to establish the communication link to the network connection apparatus 101 (step S202). In the step S202, the personal computer 130 broadcasts the DHCP request packet.

If the environment setting information (CONFIG) 121 has been set to the network connection apparatus 101 (YES, in step S203), the connecting apparatus 101 accepts the DHCP request packet.

Accordingly, the personal computer 130 acquires the local network address (local IP address) from the network connection apparatus 101 (step S207).

As described above, according to this embodiment, the communication control apparatus can access to the external network 20 such as the Internet from the internal network 30 without having to set the environment setting information to the network connection apparatus 101 and also can acquire the environment setting information to be set thereto from the external network 20.

Also, since the network connection apparatus 101 does not need a web sever function for providing the environment setting screen to the personal computer 130, a memory capacity of the apparatus 101 can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication control apparatus for executing a data transfer process between an external network and an internal network, comprising:
a first port connected to the internal network;
a second port connected to the external network;
a storage unit;
a determining unit which determines whether or not environment setting information to specify an operation environment of the communication control apparatus relating to a data transfer process of network layer level is stored in the storage unit; and
an executing unit which executes the data transfer process at the network layer level between the first port and the second port based on the environment setting information when the determining unit determinates that the environment setting information is stored in the storage unit and executes a data transfer process at data link layer level between the first port and the second port when the determining unit determinates that the environment setting information is not stored in the storage unit.

2. The communication control apparatus according to claim 1, wherein the environment setting information includes information for specifying a communication environment on a side of the internal network and a communication environment on a side of the external network.

3. The communication control apparatus according to claim 1, wherein the executing unit includes:
a first switch unit which executes the data transfer process at the data link layer level between the first port and the second port;
a second switch unit which executes the data transfer process at the network layer level between the first port and the second port based on the environment setting information; and
a selector unit which selectively connects the second port to the first and the second switch unit in response to whether or not the environment setting information is stored in the storage unit.

4. A communication control apparatus for executing a data transfer process between an external network and an internal network, comprising:
a plurality of first ports respectively connected to a plurality of network segments composing the internal network;
a second port connected to the external network;
a storage unit;
a determining unit which determines whether or not environment setting information to specify an operation environment of the communication control apparatus relating to a data transfer process of network layer level is stored in the storage unit; and
an executing unit which executes the data transfer process at the network layer level between the second port and each of the plurality of first ports based on the environment setting information when the determining unit determinates that the environment setting information is stored in the storage unit and executes a data transfer process at data link layer level among all ports including the second port and the plurality of first ports when the determining unit determinates that the environment setting information is not stored in the storage unit.

5. The communication control apparatus according to claim 4, wherein the environment setting information includes information for specifying a communication environment on a side of the internal network and a communication environment on a side of the external network.

6. The communication control apparatus according to claim 4, wherein the executing unit includes:
a first switch unit which executes the data transfer process at the data link layer level between all ports including the second port and the plurality of first ports and;
a second switch unit which executes the data transfer process at the network layer level between the second port and each of the plurality of first ports based on the environment setting information; and
a selector unit for selectively connecting the second port to the first and the second switch unit in response to whether or not the environment setting information is stored in the storage unit.

7. A method for controlling a data transfer process between an external network and an internal network executed by a communication control apparatus including a first port connected to the internal network and a second port connected to the external network, and a storage unit, comprising:
determining whether or not environment setting information for specifying an operation environment of the communication control apparatus relating to a data transfer process of network layer level is the stored in the storage unit; and
executing the data transfer process at the network layer level between the first port and the second port based on the environment setting information when the environment setting information is stored in the storage unit and executing a data transfer process at data link layer level between the first port and the second port when the environment setting information is not stored in the storage unit.

8. The method according to claim 7, wherein the environment setting information includes information for specifying a communication environment on a side of the internal network and a communication environment on a side of the external network.

9. The method according to claim 7, wherein the communication control apparatus includes:
a first switch for executing the data transfer process at the data link layer level between the first port and the second port; a second switch for executing the data transfer process at the network layer level between the first port and the second port based on the environment setting information; and a selector unit for connecting the second port to either the first switch or the second switch, and
the executing the data transfer process includes controlling the selector unit in response to whether or not the environment setting information is stored in the storage unit so as to connect the second port to the second switch when the environment setting information is stored in the storage unit and connect the second port to the first switch when the environment setting information is not stored in the storage unit.

10. The method according to claim 7, wherein the executing the data transfer process includes disconnecting a communication link between the first port and the internal network by resetting the first port when the environment setting information is written into the storage unit.
